(19) United States
(12) Patent Application Publication
(10) Pub. No.: US 2008/0270213 A1
(43) Pub. Date: Oct. 30, 2008

(54) Process risk estimation indication

(76) Inventors: Athena Christodoulou, Bristol (GB); Abdel Boulmakoul, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/789,807

(22) Filed: Apr. 24, 2007

(51) Int. Cl. G06Q 10/00

(52) U.S. Cl. 705/8; 700/51

(57) ABSTRACT

An automatic process outputs a activity failure indicator indicating the likelihood of project failure, a delay indicator indicating the likelihood of project delay, a human resource shortage indicator indicating the likelihood of a lack of human resources and an infrastructure shortage indicator indicating the likelihood of a shortage of infrastructure resources.

### FIELD OF INVENTION

The invention relates to apparatus, software and methods for process risk indication, in particular for example for project management and/or resource scheduling.

### RELATED ART

A variety of approaches to schedule projects, and/or processes exist, some of which may take into account such matters as uncertainty and resource limitation. However, complete analysis of projects, and/or processes is in general very difficult. For example, it can be very difficult to calculate the possible outcomes of changes, even very simple changes, in a schedule, in view of uncertainty and resource limitations. The difficulty is not just the distribution of times for various steps in the process but also the possibility that technical problems may arise. Further, changes in one project can easily cause conflicts with another project. For this reason, complete analytical models are not generally considered feasible at present, nor would such a model assist in identifying why a change might fail.

### SUMMARY OF INVENTION

Using the invention, an automatic process outputs one or more of an activity failure indicator indicating the likelihood of failure by reason of the failure of an activity to arrive at the correct final state, a delay indicator indicating the likelihood of delay, a human resource shortage indicator indicating the likelihood of a lack of human resources and an infrastructure shortage indicator indicating the likelihood of a shortage of infrastructure resources. The user may input changes to the processes and the system can automatically output the updated indicators resulting from the changes.

The different indicators can be calculated in different ways. In particular, in embodiments, different activities can be treated as constant when stochastically calculating the different indicators.

### BRIEF DESCRIPTION OF DRAWINGS

Embodiments of the invention will now be described, purely by way of example, with reference to the accompanying drawings, in which:

FIG. 1 illustrates the probability of a stochastic process failing;

FIG. 2 illustrates the probability and impact of four process outcomes;

FIG. 3 illustrates a high level model of a normal ITIL Change Management (CM) process;

FIG. 4 illustrates a lower level model of a specific part of a normal ITIL CM process;

FIG. 5 illustrates possible failure modes;

FIG. 6 illustrates possible human resource activity;

FIG. 7 illustrates a plan of an example ITIL CM process;

FIG. 8 illustrates a human resource view of an example ITIL CM process;

FIG. 9 illustrates an infrastructure view of the same example ITIL CM process;

FIG. 10 illustrates backout plans of an example ITIL CM process; and

FIG. 11 illustrates an embodiment of the apparatus according to the invention.

The drawings are purely schematic and not to scale.

### DETAILED DESCRIPTION

An example illustrating the invention will be described in the context of Information Technology (IT) Change Management. Of course, those skilled in the art will realise that the considerations discussed in the example are not limited to the field of IT.

A particular approach to IT change management is defined at http://www.itil-itsm-world.com. An Information Technology Information Library (ITIL) is used to aid in the framework of IT service management (ITSM). The approach defines various schedules and roles for such change management. The example described will be based on this framework.

Good management practice imposes a structure on IT operations through clearly defined processes, roles, responsibilities and guidelines. The ITIL “Change Management” (CM) process manages the lifecycle of changes in an IT environment in such a way that any negative impact to the supported business, time, cost and overall risk are minimised. The purpose of ITIL CM is to perform changes in the infrastructure in such a way that any negative impact to the supported business, time, cost and overall risk are minimised. This is achieved through careful planning that is mandatory even in the case of standard, well rehearsed changes (routine) or in changes in response to an incident (emergency). Planning activities can take a significant time, especially in the case of complex changes or changes that have not been performed before (normal).

ITIL CM processes may define a number of roles that participate in CM. The roles the metrics mainly target are those performing one or more of the activities in the CM process. These are: the Change Manager who has the overall responsibility for the successful implementation of changes in the supported IT environment for a given customer or infrastructure function; the Change Supervisor who is responsible for leading, coordinating and supervising the progress and implementation of a given change as assigned by the Change Manager; and the Change Implementer and Change Tester who respectively execute the activities in the Implementation Plan and the Test Plan.

ITIL Change Management is a complex system with roles having to make a large number of diverse decisions, for example: choose between alternative ways to implement a change; decide if a change should be performed or rejected; or finding the appropriate individual to perform an activity at a given time.

The example that will now be described involves the definition of a set of risk indicators that are calculated automatically and updated as a process goes through the different phases of its lifecycle and the managed environment conditions and human resource availability changes. The indicators aim to assist users, for example Change Managers, Supervisors and Implementers in their decisions and can be used throughout the lifecycle since they can evaluate the risk of individual change activities, whole or parts of a change plan, and change schedules.

In view of the general applicability of the invention, the term “process” will be used to describe a project, process or change in which it is desired to achieve a particular state.

### Risk and Impact Formalisation

In the embodiment, in order to automate risk and impact calculations the notions of risk and impact are formalized.

Risk is defined to be the combination of the probability of an abnormal outcome and its consequences (impact). This focuses on the probabilistic aspects of risk. The purpose of a process is to alter the state from a state sysᵢₙᵢₜ to a desired state sys_{target} by a deadline d. The process is realised by a set of activities {αᵢ, αⱼ, . . . αₙ} and a set of precedence constraints between activities αᵢ<αⱼ prescribed by the corresponding process.

Assume that at time t₀ a request for change (RFC) is submitted that explicitly specifies a desired state sys_{target} and a deadline d>t₀ by which the change, described here as a process, must be implemented. The process will be successful if by the deadline d the process is in a phase after the Test/Implementation phase and the infrastructure is in the desired state sys_{target} while the process fails if by the deadline d is in a state different than sys_{target}. Hence, the probability of a process being successful depends on the time taken to perform all process activities up to and including its implementation phase.

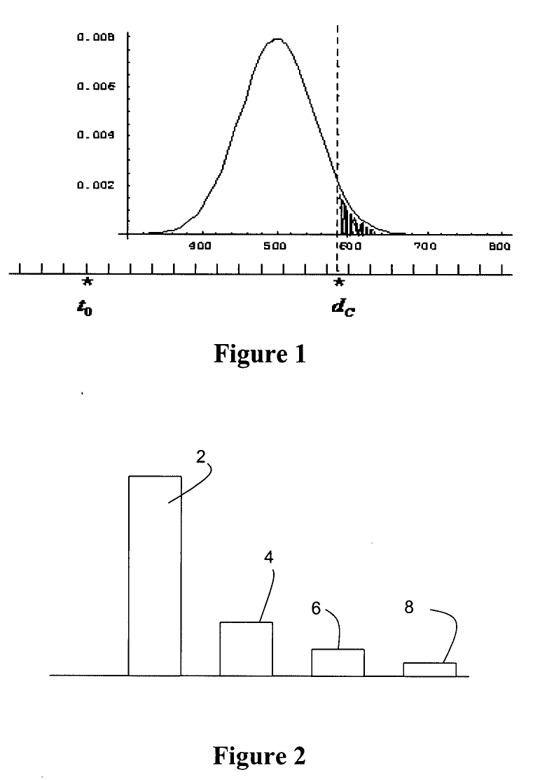

FIG. 1 shows a distribution of the duration of a process along with its deadline and submitting time. The shaded area under the curve is the probability of the process failing, in other words the probability part of risk that it is given by:

Pr[Sys(d)≠sys_{target}].

Let i₁,i₂ . . . iₘ be a set of metrics expressing the impact to an organisation when the supporting infrastructure is in a state sysᵢ. In order to analyse the risk of a process, the desired state sys_{target} must be known as also any states sys_{ε}_{₁}, sys_{ε}_{₁}, sys_{ε}_{ₙ} the infrastructure may end up, in if the process fails. Hence, the overall likelihood of failure is given by

$$Pr [ Sys ( d ) ≃ {sys}_{target} ] = {\sum }_{i = 1}^{n} Pr [ Sys ( d ) = {sys}_{{ɛ}_{i}} ]$$

and for each unsuccessful outcome state sys_{ε}_{ᵢ} the risk is given by a probability Pr[Sys(d)=sys_{ε}_{ᵢ}] and a vector of impact metrics [iᵢ(Sys_{ε}_{ᵢ}), i₂(Sys_{ε}_{₂}) . . . iₘ(Sys_{ε}_{ᵢ})].

These concepts are illustrated in FIG. 2 that shows the risk of four possible outcomes one of which is the successful implementation of a process. Success is indicated by bar 2, and three different failure probabilities are indicated by bars 4, 6 and 8.

Unfortunately any attempt to determine the possible outcomes of simple, even a routine process on an elementary infrastructure proves that such a task is far from trivial. The complexity is down to uncertainty and resource limitations. The uncertainty in the context of CM is introduced by the stochastic (i.e. random) duration of change activities and also the possibility of technical problems that may arise during activity execution. Resource limitations exist for both infrastructure resources and human resources introducing conflicts between activities of the same or different change processes that may be in progress at the same time. The above interdependencies mean that an analytical model to decide the probability space of a change is not practically feasible. Furthermore, even if an analytical model was feasible, it does not help the decision maker to identify any reasons why a change may fail, which is essential in deciding what action to take in order to reduce the risk.

### Alternative Risk Indicators

The alternative risk indicators that this patent application proposes are based on the observation that processes may fail for one or more of the following reasons:
activities took longer than expected;
something went wrong in the execution of activities;
the human resources were not available to perform activities;
the infrastructure resources required were not available to perform the activities.

Note that the above outcomes are not independent making any complete calculation of the probability of the process being unsuccessful generally too complex for practical use.

In the embodiment, four respective indicators are calculated, namely a delay indicator, a activity failure indicator, a human resource shortage indicator and a infrastructure shortage indicator, indicating the risk that a process fails for each of the respective reasons above.

Importantly, the four outcomes above indicate different types of problems for which different corrective action must be taken. We therefore define for each of the above cases a corresponding risk probability metric: P[activity failure] for the risk of activity failure; P[activity delay] for the risk of longer activity durations; P[human resource shortage] for human resources shortage; and P[IT resource shortage] for the shortage of infrastructure resources.

In order to estimate the indicators automatically the following models are in place in the embodiment: (a) the infrastructure on which the process will take place; (b) the process itself; (c) the SLAs that specify the service levels the infrastructure must deliver; and (d) the human resources that will perform the process.

The infrastructure and SLA models are used to estimate the consequences (impact) of process activities and of the possible outcomes. The probabilistic aspects of risk rely on the process, human and infrastructure resource models and can be seen as extensions of the existing information models.

### Process Model Development

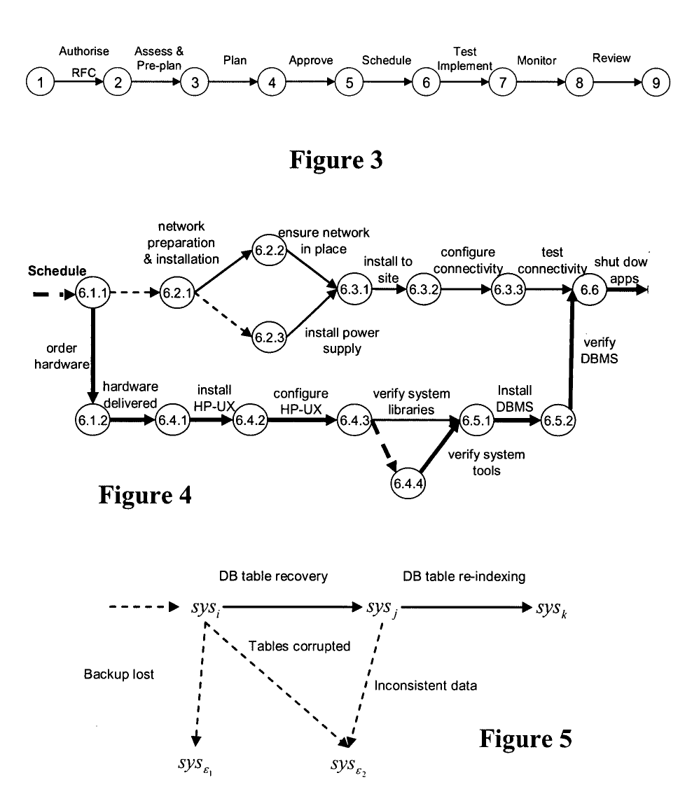

We view planning a process as a model refinement process, where starting from a generic process model, activities are decomposed into simpler activities until a plan of the desired detailed is generated. Note that in its simplest form, the generic model of a process consists of activities that correspond to the phases of the appropriate Change Management process. For example FIG. 3 shows the “high-level” activities of a normal process.

The activities Plan and Test/Implement are defined in further detail during planning. Note that it may take several implementations of a process until a detail model is achieved. For example a detailed model of the implementation phase of a database (DB) server build and migration project can be seen in FIG. 4.

Each process activity has: a duration (specified as a random variable), human resource needs (role and skills), infrastructure resource needs (on which configuration item the activity is applied), and a failure vector (possible technical failures that can occur during an activity along with their probability of occurrence). FIG. 5 illustrates the identified possible activity failures in two activities of a DB table recovery.

The properties of “high-level” activities are determined recursively from the properties of more detailed activities. We must emphasise that stochastic nature of the proposed approach can cope with “incomplete” models making them suitable to evaluate processes at different stages of maturity and/or planning phases.

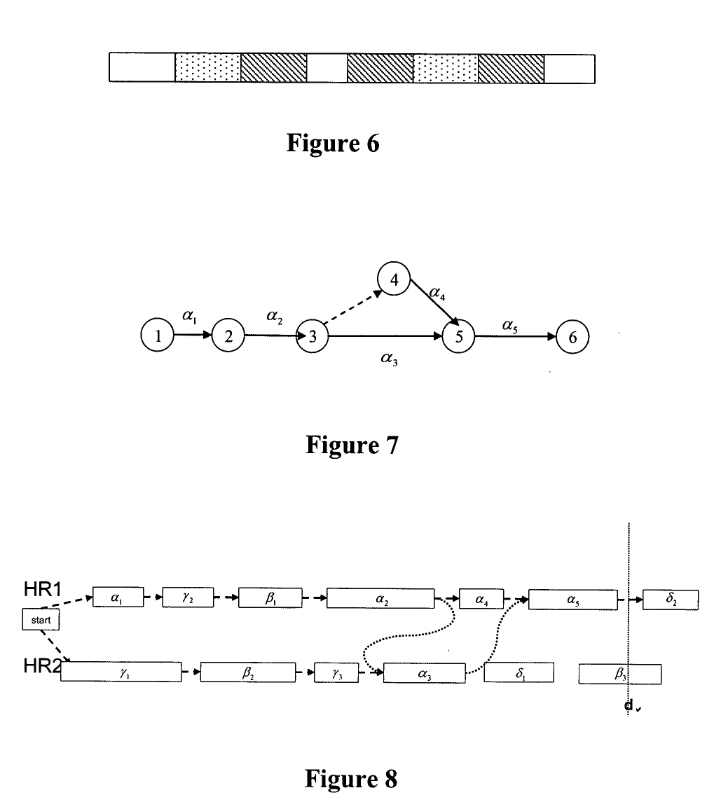

The human resources model assumes that each individual has a set of permitted roles, and a set of skills. Activities are assigned to individuals by assigning them a role in a change. Note that a human resource can take several roles in a number of process and a a process may be performed by more than one individual. At any given moment in a working day a human resource will either be busy performing an assigned activity or it will be idle (two possible states). FIG. 6 shows the workload of a human resource, that is the activities assigned to that individual. The striped areas represent activities belonging to a given process, the dotted areas time that the individual is expected to be busy doing other activities, and the white areas represent idle time.

The model for infrastructure resources (configuration items) depends on the sophistication of the underlying infrastructure model. Nevertheless, as in the human resources model, activities will be scheduled to take place on one or more configuration items. Note that for the majority of the time infrastructure resources will be in their normal operational state and their state will change only due to a activity failure or when a change takes place on them or on components they depend on. Activities in the Test/Implement phase of processes make use of infrastructure resources and typically these activities are also prone to technical failures. Hence, infrastructure resources differ from human resources in two ways: (1) while in the case of human resources one activity affects the status of only the individual it was assigned to, an activity in the case of infrastructure resources can affect the status of more than one infrastructure resource; and (2) while human resources are either idle or busy, infrastructure resources can be in several different states.

Consider infrastructure consisting of three web servers, two application servers, and one database server. Applying a patch to a host is regarded as a separate process. In order to patch a host, all applications running on that host must be stopped. While the effect of patching one of the three web servers results in extra load to the remaining two servers, and similarly patching one of the application servers will increase the load on the remaining application server, the patching of the database host will bring down the service and for this reason it is scheduled to take place within a predefined maintenance window that starts at midnight. Hence, the effect of an activity (e.g. applying the patch) on a configuration item does not only depend on the nature of the activity and the type of the configuration item but also on the specific function that the configuration item has in the service hierarchy. Note also that the state of other configuration items is affected by the activity.

### Scheduling of Activities

All activities of a process undergo some type of scheduling, in the sense that an activity is assigned to a human resource to take place within a given time interval. During scheduling any human and infrastructure resource conflicts of activities of the process being scheduled with activities of the same or other processes in progress are resolved. Note that while a process may define an explicit Scheduling phase for the activities of the Test/Implement phase, most of their predecessor activities (except the Authorisation phase activity that is always performed by the Change Manager) are “scheduled” when the Change Supervisor role for the change is assigned to an individual. However, since process plans may be altered several times during planning, a process may change and hence may go through a number of different schedules in its lifetime. Hence scheduling introduces additional precedence constrains to a change. For example consider the process plan (SAN) of FIG. 7 consisting of six activities.

Assume that all activities are assigned to individual HR1 except activity α₃ that is assigned to HR2. FIG. 8 shows a possible schedule of the process and the additional precedence constrains that the schedule introduces (only HR dependencies shown).

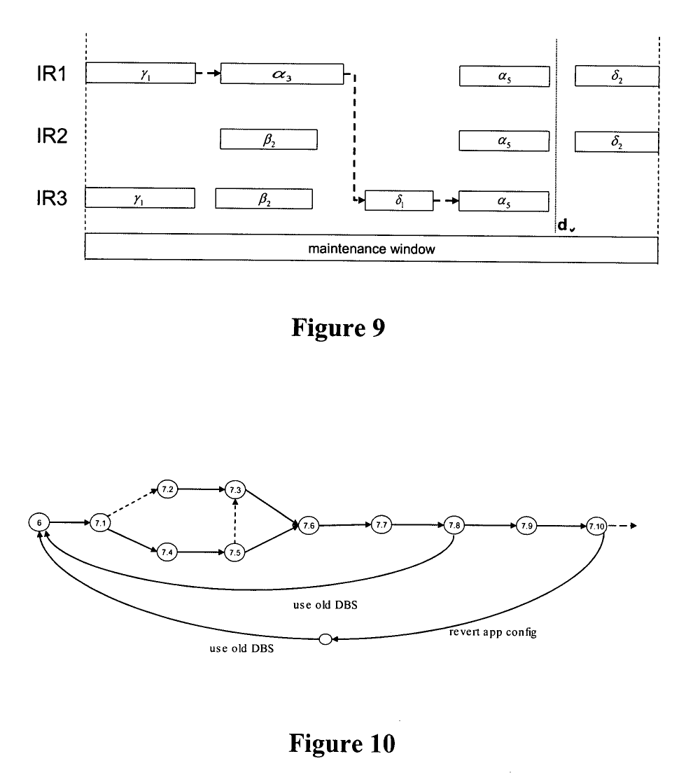

Assuming that only activities α₃ and α₅ alter the state of the infrastructure. FIG. 9 shows a schedule of the same change with respect to infrastructure resources. Note that activity α₅ affects the state of all three infrastructure resources, while activity α₃ affects only resource IR1.

To simplify the scheduling of activities, it is common to assume that their duration is deterministic. Hence when an activity a=(eᵢ, eⱼ) whose duration is given as a random variable D(a)=tᵢⱼ is scheduled, it is assigned to it a time interval of fixed length SD(α) that will typically be smaller than the maximum value that D(α) can take. For this reason, resource conflicts will never be fully resolved by a schedule and the risk of a schedule needs to be assessed every time an activity starts/completes, when new activities are assigned to individuals or when schedules alter.

### Indicator Estimation

The four risk indicators (delay, activity failure, human resource and infrastructure resource) are used to evaluate process plans and schedules. Note that none of the indicators shows the true “state-of-the-world”. All four must be used in conjunction to give a realistic view of the risks. In this section we will outline how the indicators are calculated, their meaning and the action that needs to be taken to reduce the risk they are referring to.

In alternative embodiments, different ways of calculating the indicators are possible (for example using a queue model instead of a SAN to estimate human resource risk). Note that several different indicators can be calculated depending on the phase the change is in and the specific question the decision maker is asking. Also note that knowledge of the way that durations are distributed may allow more precise calculation of indicators (no need to rely on central limit theorem). A large number of indicators can be defined each answering a slightly different question of the decision maker. The following indicators are the ones that address some common decisions and illustrate the principle behind the invention.

The delay, failure, human resource and infrastructure resource risk indicators of the present example are all calculated based on stochastic activity network (SAN) models from which the probability of completing of the change activities by the deadline is derived. In all cases we rely on finding some form of a critical path in the SAN, and calculating its makespan. Note that for simplicity we will assume that enough activities are included in the critical path of a change for the makespan to be normally distributed, however this assumption cannot hold in all cases and other distributions, closed under summation need to be considered (e.g. phase distributions). The activities that form the critical path used in each indicator differ since we want each indicator to highlight a different aspect of risk.

For this reason in the case of the delay risk indicator for a change, to take into account only the uncertainty introduced by the duration of the activities of the given change and the precedence constrains among them, we consider as random variables only the activities of the process of interest. All other activities or idle time in the schedule are considered to be constants. The critical path is determined using both random and constant activities but the variance in the makespan is only down to the activities of the process of interest. In other words, the indicator shows if the time assigned to the process is enough for the process to take place on time. The way that the assigned time to a process is calculated will depend if the activities are scheduled or not. If there has been assigned to the activities of the change an interval in which it must take place, this number is used. If not, the available time intervals are calculated by subtracting the sum of all constant activity durations in the critical path from the length of interval that the process must take place (change deadline—time of RFC submission). The delay risk for the process will be the probability that the makespan of the critical path is larger than the available time. There are two ways to reduce such risk: to use alternative plans of shorter duration, or to reschedule all activities of other processes to later times leaving more available time to the process of interest. Note that the corresponding delay indicators of processes whose activities appear as constants in the critical path of the former activity will be affected and need to be updated. For example if the critical path of the change of FIG. 7 is π=α₁, α₂, α₃, α₅> and when it is scheduled to calculate the HR shortage indicator as shown in FIG. 8 the critical path must be calculated again.

The critical path when calculating the HR shortage indicator is not necessarily the same as that used in calculating the delay indicator. The critical path for the HR shortage indicator will be referred to as the human resource critical path and the critical path for the delay indicator the delay critical path.

For the delay indicator, there are two paths to consider π′=<α₁, x2, β₁, α₂, α₃, α₄, α₅> and π″=<x1, β₂,x3, α₃,α₄,α₅> and assume that π′ is the longest of the two, i.e. the delay critical path. Recall that all activities that do not belong to the process of interest are constants hence D(x2)=SD(x2) and D(β₁)=SD(β₁) so the only random variables in the current critical path π′ are α₁, α₂, α₃, α₄ and α₅. Let D_{π′} be the makespan of the critical path π′ where only those activities that belong to C_{α} are random variables (have a non-zero variance V(α)≠0). Hence the expected process duration will be

$${\overline{D}}_{{π}^{′}} = {\sum }_{a ∈ π ⋀ a ∈ {C}_{α}} \overline{D} ( a ) + {\sum }_{a ∈ {π}^{′} ⋀ a ∉ {C}_{α}} D ( a ) with {σ}_{{π}^{′}} = \sqrt{{\sum }_{a {∈}^{′} ⋀ a ∈ {C}_{α}} V ( a )} .$$

The delay risk indicator for process

$${C}_{α} is 1 - Pr [ {D}_{{π}^{′}} \leq {\sum }_{a ∈ {π}^{′}} SD ( a ) ] .$$

Human resource risk indicators express the likelihood of delaying the process due to human resource shortage. To achieve this we construct a critical path for the process where the durations of all the activities assigned to individuals that participate in a process are now random variables. The potential paths in FIG. 8 are the same as before, only this time assume that activities χ₁, β₂ and χ₃have a large variance and as a result the human resource critical path for process C_{α} now becomes π″=<x1,β₂, x3,α₃,α₄, ═₅>. The human resource risk indicator for process C_{α} is similarly calculated as

$$1 - Pr [ {D}_{{π}^{′}} \leq {\sum }_{a ∈ {π}^{″}} SD ( a ) ]$$

only this time

$${\overline{D}}_{{π}^{′}} = {\sum }_{a ∈ {π}^{″}} D ( a )$$

Note that in the calculation of the path for the HR indicator we assume that infrastructure resources will always be available, hence we view the duration of any activities introduced to model just IT resource constrains (i.e. activities that have no human resource requirements) being constant with D(a)=SD(a). Note that the paths generated from both the human resource and infrastructure resource schedules must be taken into account in order to decide which activities form the critical path.

In a similar way the infrastructure risk indicator is calculated. Infrastructure risk makes sense only in activities that modify the infrastructure, and typically these are scheduled to take place within a predefined maintenance window as FIG. 9 illustrates. Hence, the corresponding infrastructure risk indicator will consider all activities that do not modify the infrastructure to have a constant duration since we assume that the human resources will be available to perform all other activities on time. For example in the case of process C_{α} only activities γ₁,β₂, α₃, δ₁, α₅ and δ₂ are considered to form the infrastructure critical path and the indicator is the probability of their makespan being larger than the allocated time.

The calculation of the activity failure risk indicator of a process will be performed differently if backout plans have been defined or not. Before backout plans are defined the activity failure risk indicator of a change C_{α} depends only on the failure events defined and their probabilities and it expresses the likelihood of a technical or other failure preventing the completion of the process (process duration infinite). Only activities of the process in question are taken into account, and this time all activities in are taken into account (no critical path).

Consider process P with activity set A={α₁, . . . , α₁, . . . α_{|A|}} and assume that each activity has a (possibly empty) set of mutually exclusive faults Faults(αᵢ)={f_{i,1}, f_{i,2}, . . . f_{i,|Faults(α}_{ᵢ}_{)|}}.

The probability of activity αᵢ being performed without a fault is:

$$Pr [ nofault ( {α}_{i} ) ] = 1 - {\sum }_{j = 1}^{\vert Faults ( {a}_{i} ) \vert} Pr [ {f}_{i , j} ]$$

and Pr[fault(αᵢ)]=1Pr[nofault(αᵢ)]. For a process to complete without a fault, every activity of the process must finish without a fault, hence:

$$Pr [ nofault ( P ) ] = {\prod }_{{α}_{i} ∈ {A}_{α}} Pr [ nofault ( {α}_{i} ) ]$$

and the probability of not being able to complete the process due to a fault is simply Pr[fault(P)]=1−Pr[nofault(P)].

Note that every time an activity executes without fault the probability of completing the a process without a fault Pr[nofault(P)] increases by:

$$Pr [ nofault ( P ) \vert nofault ( {α}_{i} ) ] = \frac{Pr [ nofault ( P ) ]}{Pr [ fault ( {α}_{i} ) ]}$$

When backout plans are defined that either complete the process in a different way or return the infrastructure in its state before the process was attempted, the time that the backout plan will take to be executed if a activity failure occurred can be calculated. For example, FIG. 10 shows an implementation plan in less detail along with the backout plans (shown in red) that will be executed if a problem occurs during the DB migration or when the applications that use the DB are redirected.

In the case of a high probability of technical activity failure, the decision maker can calculate the indicators discussed previously for plans of the process when a activity failure occurs and a backout plan needs to be executed. Since backout plans may take a longer time to execute than the remaining activities of the original plan and/or may have different human resource or infrastructure requirements calculating the delay, human and infrastructure resource indicators can help the decision maker ensure that if a activity failure occurs the execution of any backout plans will be possible to take place on time.

The above calculations are applicable to processes whose activities are fully planned and have been assigned to individuals. At early stages of planning when the way that the process will be implemented is not known, the indicators can be still calculated using preliminary schedules and “high-level” plans. For example, in the case of the database (DB) migration implemented as a normal change, the ITSM normal process phases stand for the activity and we assume that only the DB server will be affected by the implementation. Furthermore, if the process is not yet assigned to an individual we identify the set of individuals that satisfy the role and skills requirements, find the workload of each resource and check the probability that the idle time of one of them is enough to perform the process on time.

The indicators when calculated differently can guide the decision maker to pinpoint the cause of an increased risk. For example, to identify which individual is responsible for an increased human resource risk, the human resource indicators can be calculated for each individual participating in a process. The indicator for each individual assumes that all activities assigned to other individuals are of constant duration and only the activities of the individual for which the indicator is estimated are random variables.

Similar indicators can be calculated for individual activities. For example the probability of completing an activity within its allocated time interval, given that the activity starts on time can be very useful in pinpointing those activities that have a high delay risk. Furthermore, the corresponding indicators expressing the likelihood of not starting an activity on time can help identify the reasons behind an increased risk. The different indicators can be utilised in an expert system diagnosing the underlying cause of likely failure and proposing alternative solutions to the decision maker. For example, if the delay risk for an activity starting on time is low but the risk of ending the activity on time is high, then the time interval assigned to the activity is not large enough. If the human and/or infrastructure resource risk for the activity is also high then the workload assigned to the human or infrastructure resource to be performed before the activity in question is responsible. If both the human and infrastructure resource risk for the activity are low then the problem is down to the way the change is implemented and the only solution is to alter the plans.

In an alternative way of carrying out the calculations, the indicators can be calculated in a method in which the duration of all activities of all processes are treated as random variables. In this case, human resource, delay and infrastructure risk indicators are equivalent and the resulting likelihood approximates the risk probability shown in FIG. 1.

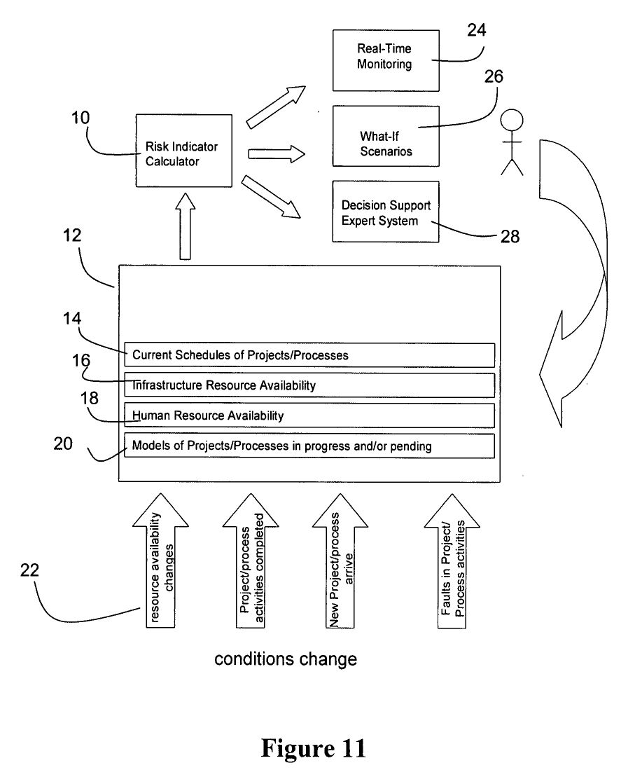

A system is illustrated in FIG. 11 that is used to carry out the automatic processing as described above. It includes a common general purpose computer 10 with a data store 12 storing current schedules of processes 14, infrastructure resource availability 16, human resource availability 18, and models of processes in progress and/or pending as one or more files. Changes to these are recorded in the data store as indicated schematically by arrows 22.

The general purpose computer 10 is programmed with software to carry out the methods as set out above.

The output from the computer 10 is passed to one or more of a real time monitoring system 24, a record of what-if scenarios 26 and/or a decision support expert system 28.In use, a user enters data into the data store 12 computer then runs risk indication calculator software to calculate the delay indicator, the activity failure indicator, the human resource shortage indicator and the infrastructure shortage indicator. These are then output on display 12 or elsewhere by output module 20.

The user can change the data representing the activities and states of the system, in the light of a change in processes or the outcomes of events as indicated schematically 22. Furthermore, as FIG. 11 indicates, the software that implements the proposed method for risk indication can receive input about any changes in processes and/or outcomes and/or schedules and/or resource availability through other software that monitors the current status of processes/activities and/or resources. The computer 10 then automatically recalculates the delay indicator, the activity failure indicator, the human resource shortage indicator and the infrastructure shortage indicator based on these changes, and outputs the updated risk indicators.

Those skilled in the art will appreciate that there are many ways of implementing this or other approaches to carrying out the steps described above. The computer 10 can be networked or stand-alone, and the data may be stored in many different ways.

The above embodiment calculates the activity failure indicator, the delay indicator, the human resource shortage indicator and the infrastructure shortage indicator indicating the likelihood of a shortage of infrastructure resources in different ways using slightly different models, but in an alternative approach all of these are calculated using a stochastic model of every modelled activity, whether or not from the project in question or having specific properties. In this case, a single critical path may be used.

The above description defines files in data store 12 acting as a definition means for the indicators and specifying means specifying activities. Those skilled in the art will realise that any suitable data store and format may be used, including different storage forms, memories and the like. Further, in the above embodiment a calculation means and an output means are constituted by a general purpose computer, but any suitable combination of hardware and software can be used. The various elements can be in a single housing or combined and linked, for example by a computer network.

Although the above example relates to an IT process the same system can of course be used for other project or change or process managements in other fields.

We claim:

1. A process evaluation method, comprising, in a computer system: defining a plurality of classes of indicators, including an activity failure indicator indicating the likelihood of process failure as result of failure of one or more activities, a delay indicator indicating the likelihood of process delay, a human resource shortage indicator indicating the likelihood of a lack of human resources and a infrastructure shortage indicator indicating the likelihood of a shortage of infrastructure resources; specifying a plurality of activities making up at least one process, each activity having defined initial and final states, a human resource requirement, an infrastructure resource requirement, a duration and optionally information regarding possible failure; and for at least one process, calculating the activity failure indicator, the delay indicator, the human resource shortage indicator and the infrastructure shortage indicator indicating the risks to the project using a probabilistic calculation in the computer system; and outputting at least one of the activity failure indicator, the delay indicator, the human resource shortage indicator and the infrastructure shortage indicator.

2. A process evaluation method according to claim 1, further comprising: changing the specifications of one or more of the activities as one or more change; and updating the activity failure indicator, the delay indicator, the human resource shortage indicator and the infrastructure shortage indicator indicating the risks to the project to indicate the risk and impact of the one or more change.

3. A process evaluation method according to claim 1, further comprising: calculating the delay indicator for a process by identifying the delay critical path and the probability of delay, treating as random variables the activities of the said process and by treating as a constant the activities of any other process.

4. A process evaluation method according to claim 1, further comprising: calculating the human resource shortage indicator for a process by identifying the human resource critical path and the probability of delay, treating as random variables the human resource requirements of all activities of the said process and of other processes and treating as a constant the infrastructure requirements of all activities.

5. A process evaluation method according to claim 1, further comprising: calculating the infrastructure shortage indicator for a process by identifying the infrastructure critical path and the probability of delay, treating as random variables the infrastructure requirements of all activities that require infrastructure and treating as a constant all activities that do not require infrastructure.

6. A process evaluation method according to claim 1, further comprising: calculating the activity failure indicator for a processs by treating all activities of the process as random variables and all other activities as constants, whether or not the activities are on a critical path.

7. A process evaluation method according to claim 1, further comprising: defining a backout plan defining for at least one predetermined failure state one or activities to be implemented in the event the predetermined failure state is reached; and calculating the time taken to take the steps in the process and the activities to be implemented in the event the predetermined failure state.

8. A process evaluation method according to claim 1, further comprising calculating the delay indicator, the activity failure indicator, the human resource shortage indicator and the infrastructure shortage indicator for one or more specific activities or groups of activities.

9. A process evaluation method according to claim 1 further comprising calculating the delay indicator, the activity failure indicator, the human resource shortage indicator and the infrastructure shortage indicator for a process by identifying the delay critical path and the probability of delay, treating as random variables the activities of the said process and other processes.

10. A process evaluation system comprising:
at least one file defining a plurality of human and infrastructure resources;
at least one file defining the activities of at least one process, wherein for each activity the at least one file specifies:
the duration of the activity as a random variable;
the human and infrastructure resource requirements of the activity;
and optionally a vector of activity faults that can occur during activity execution that will prevent the process/project completing as planned, wherein for each possible activity fault the vector specifies the probability of each fault occurring and optionally an alternative set of activities that will be executed instead of the original ones if the fault occurs; and
probabilistic calculation means for calculating for at least one process the activity failure, delay, human resource shortage and infrastructure resource shortage indicators

11. A process evaluation system according to claim 10,
wherein the probabilistic calculation means is arranged:
to calculate the delay indicator for a project by identifying the delay critical path and the probability of delay, treating as random variables the activities of the said project and by treating as a constant the activities of any other project.

12. A process evaluation system according to claim 10,
wherein the probabilistic calculation means is arranged:
to calculate the human resource shortage indicator for a project by identifying the human resource critical path and the probability of delay, treating as random variables the human resource requirements of all activities of the said project and of other projects and treating as a constant the infrastructure requirements of all activities.

13. A process evaluation system according to claim 10,
wherein the probabilistic calculation means is arranged:
to calculate the infrastructure shortage indicator for a project by identifying the infrastructure critical path and the probability of delay, treating as random variables the infrastructure requirements of all activities that require infrastructure and treating as a constant all activities that do not require infrastructure.

14. A process evaluation system according to claim 10,
wherein the probabilistic calculation means is arranged:
to calculate the activity failure indicator for a project by treating all activities of the project as random variables and all other activities as constants, whether or not the activities are on a critical path.

15. A computer program recorded on a data carrier, comprising
definition files defining a plurality of classes of indicators, including a activity failure indicator indicating the likelihood of project failure, a delay indicator indicating the likelihood of project delay, a human resource shortage indicator indicating the likelihood of a lack of human resources and a infrastructure shortage indicator indicating the likelihood of a shortage of infrastructure resources;
code for allowing user definition of a plurality of activities making up at least one project, each activity having defined initial and final states, a human resource requirement, an infrastructure resource requirement, a duration and a failure vector, the failure vector defining for each failure a respective final state resulting from the failure and a respective probability; and
and code for stochastically calculating the activity failure indicator, the delay indicator, the human resource shortage indicator and the infrastructure shortage indicator indicating the risks to the project for at least one project.

16. A computer system, comprising:
definition means defining a plurality of classes of indicators, including an activity failure indicator indicating the likelihood of process failure as result of failure of one or more activities, a delay indicator indicating the likelihood of process delay, a human resource shortage indicator indicating the likelihood of a lack of human resources and a infrastructure shortage indicator indicating the likelihood of a shortage of infrastructure resources;
specifying means specifying a plurality of activities making up at least one process, each activity having defined initial and final states, a human resource requirement, an infrastructure resource requirement, a duration and optionally information regarding possible failure;
calculation means for calculating the activity failure indicator, the delay indicator, the human resource shortage indicator and the infrastructure shortage indicator indicating the risks to the project using a probabilistic calculation in the computer system; and
output means for outputting at least one of the activity failure indicator, the delay indicator, the human resource shortage indicator and the infrastructure shortage indicator.
